(19) United States
(12) Patent Application Publication
(10) Pub. No.: US 2025/0209640 A1
(43) Pub. Date: Jun. 26, 2025

(54) APPARATUS AND METHOD FOR MEASURING SPIN DATA OF ROTATING OBJECT

(71) Applicant: VC INC., Seoul (KR)

(72) Inventors: Hye Rim Cheon, Gwangju-si (KR); SANG IL JIN, Incheon (KR)

(21) Appl. No.: 18/983,493

(22) Filed: Dec. 17, 2024

(30) Foreign Application Priority Data
Dec. 21, 2023 (KR) 10-2023-0188961

(51) Int. Cl. G06T 7/246; G06T 3/60; G06T 7/60; G06T 7/73

(52) U.S. Cl. CPC G06T 7/248; G06T 3/60; G06T 7/60; G06T 7/74; G06T 2207/30204

(57) ABSTRACT

Disclosed is an apparatus for measuring spin data of a rotating object, which includes: a rotating object detection unit detecting an image of a rotating object with respect to an image of n frames captured by a camera; a coordinate extraction unit extracting location coordinates of a marker in the rotating object image detected by the rotating object detection unit; a spin data storage unit in which spin data of the rotating object is stored in advance; and a spin data derivation unit deriving final spin data based on the spin data of the rotating object stored in the spin data storage unit and the location coordinates of the marker extracted by the coordinate extraction unit. According to exemplary embodiment of the present disclosure, spin data of a rotating object can be derived through only mapping pixel location coordinates of a rotating object marker, and spin data stored in a spin data storage unit constructed in advance, without conversion of actual space coordinates for the marker coordinates for the rotating object, so the spin data of the rotating object can be measured with a high speed and a small computation amount.

### CROSS-REFERENCE TO RELATED APPLICATION

This application claims priority to and the benefit of Korean Patent Application No. 10-2023-0188961 filed in the Korean Intellectual Property Office on Dec. 21, 2023, the entire contents of which are incorporated herein by reference.

### BACKGROUND OF THE INVENTION

### (a) Field of the Invention

The present disclosure relates to an apparatus and a method for measuring spin data of a rotating object, and more particularly, to an apparatus and a method for measuring spin data of a rotating object, which can derive spin data of a rotating object by using a spin data database of the rotating object and pixel coordinates of a rotating object marker captured by a camera.

### (b) Description of the Related Art

Information required for predicting flight distances of spherical objects such as golf balls and baseball balls includes flight location information, speed information and rotation amount information. Among them, the rotation amount information requires a complex computational process using a lot of formulas, so it is difficult to calculate and apply a real-time rotation amount to spherical objects flying at high speeds.

Korean Patent Registration No. 10-1738973 proposes a method for measuring a rotation amount of a spherical rotating object by forming a marker at an appropriate location of an external surface of the rotating object, and tracking a marker change in a frame obtained by the camera

However, the patent has a problem in that since a process of converting pixel coordinates for a rotating object marker obtained from a camera image into an actual space coordinate system is required, it is difficult to measure spin data of the rotating object with a high speed and a small computation amount.

### SUMMARY OF THE INVENTION

The present disclosure attempts to provide an apparatus and a method for measuring spin data of a rotating object, which can derive spin data of a rotating object through only mapping pixel location coordinates of a rotating object marker obtained from a camera, and spin data stored in a spin data storage unit constructed in advance.

An exemplary embodiment of the present disclosure provides an apparatus for measuring spin data of a rotating object, which includes:
a rotating object detection unit detecting an image of a rotating object with respect to an image of n frames captured by a camera; a coordinate extraction unit extracting location coordinates of a marker in the rotating object image detected by the rotating object detection unit; a spin data storage unit in which spin data of the rotating object is stored in advance; and a spin data derivation unit deriving final spin data based on the spin data of the rotating object stored in the spin data storage unit and the location coordinates of the marker extracted by the coordinate extraction unit.

The apparatus may further include a mapping unit mapping the spin data of the rotating object stored in the spin data storage unit and the location coordinates of the marker extracted by the coordinate extraction unit, and deriving an angle of a common rotation axis and a difference of a rotation amount, and the spin data derivation unit may derive the final spin data including a rotation axis and a spin rate based on the angle of the common rotation axis and the difference of the rotation amount derived by the mapping unit.

The spin data of the rotating object stored in the spin data storage unit may include a rotation axis angle and a rotation amount angle of the rotating object, and location coordinates of a marker, and the spin data of the rotating object is derived by a 3D simulator.

The spin data of the rotating object may be stored in the spin data storage unit for each type of rotating object distinguished according to the number of markers or a shape of the marker

The mapping unit may extract a rotation axis angle list and a rotation amount angle list mapped to each location coordinate of the rotating object marker from the spin data storage unit based on the location coordinate list of the marker extracted by the coordinate extraction unit, and extract the common rotation axis, and derives the angle of the common rotation axis based on the extracted rotation axis angle list and rotation amount angle lists.

Another exemplary embodiment of the present disclosure provides a method for measuring spin data of a rotating object, which includes:
a first step of detecting an image of a rotating object with respect to an image of n frames captured by a camera; a second step of extracting location coordinates of a marker within the detected rotating object image; and a third step of deriving final spin data based on spin data of the rotating object stored in advance in a spin data storage unit and the extracted location coordinates of the marker.

The method may further include a fourth step of storing the spin data of the rotating object derived by using a 3D spin simulator in the spin data storage unit.

The spin data of the rotating object may be stored in the spin data storage unit for each type of rotating object distinguished according to the number of markers or a shape of the marker.

The third step may include mapping the spin data of the rotating object stored in the spin data storage unit and the extracted location coordinates of the marker, and deriving an angle of a common rotation axis and a difference of a rotation amount, and deriving the final spin data including a rotation axis and a spin rate based on the derived angle of the common rotation axis and the difference of the rotation amount.

The fourth step may include setting a range of a rotation axis angle of the rotating object and a range of a rotation amount angle of the rotating object to be constructed as a database, combining the rotation axis angle and the rotation amount angle within the set ranges, and obtaining rotation images of multiple rotating objects, recognizing a marker from the obtained rotation image of the rotating object, and deriving location coordinates of the marker on the image, and mapping the spin data of the rotating object and a location of the marker, and storing the mapped spin data and location of marker in the spin data storage unit

The driving of the angle of the common rotation axis and the difference of the rotation amount may include
receiving a storage path in which the spin data is stored, and a list of the extracted location coordinates of the marker, extracting a rotation axis angle list and a rotation amount angle list mapped to each location coordinate of the rotating object marker from the spin data storage unit based on the received location coordinate list of the marker and the storage path, extracting the common rotation axis in the frame, and derives the angle of the common rotation axis based on the extracted rotation axis angle list and rotation amount angle lists, and deriving a difference value between a rotation amount mapped for each extracted common rotation axis, and a common rotation amount.

The deriving of the final spin data may include generating rotating object marker location coordinate lists of n frames based on the extracted location coordinates of the marker, extracting spin data mapped to the rotating object marker location coordinate lists of n frames from the spin data storage unit, and deriving common spin data common to the extracted spin data, and deriving the final spin data based on the common spin data.

The deriving of the final spin data based on the common spin data may include setting a mean rotation axis angle of multiple common rotating objects to a final rotation axis angle, and deriving a spin rate of the rotating object based on a mean of a rotation amount difference of the rotation axis, and a frame rate, and deriving the final spin data including a final rotation axis, a final back spin rate, and a final side spin rate based on the derived final rotation axis angle and the spin rate of the rotating object.

According to exemplary embodiment of the present disclosure, spin data of a rotating object can be derived through only mapping pixel location coordinates of a rotating object marker, and spin data stored in a spin data storage unit constructed in advance, without conversion of actual space coordinates for the marker coordinates of the rotating object, so the spin data of the rotating object can be measured with a high speed and a small computation amount.

### BRIEF DESCRIPTION OF THE DRAWINGS

FIG. 1 is an explanatory diagram schematically illustrating a configuration of an apparatus for measuring spin data of a rotating object according to an exemplary embodiment of the present disclosure.

FIG. 2 is a flowchart for describing a method for measuring spin data according to an exemplary embodiment of the present disclosure.

FIG. 3 is a detailed flowchart for step S10 of FIG. 2.

FIG. 4 is a detailed flowchart for step S50 of FIG. 2.

FIG. 5 is a detailed flowchart for step S60 of FIG. 2.

FIG. 6 is a diagram illustrating an example of a computing device according to an exemplary embodiment of the present disclosure.

### DETAILED DESCRIPTION OF THE EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

Devices described in the present disclosure are constituted by hardware including at least one processor, a memory device, a communication device, etc., and a program executed in combination with the hardware is stored in a designated place. The hardware has a configuration and a performance which may execute a method of the present disclosure

The program includes instructions implementing an operation method of the present disclosure described with reference to drawings and executes the present disclosure in a combination with hardware such as the processor and the memory device.

In this specification, “transmission or providing” may include indirectly transmitting or providing through another device or by using a bypass path in addition to direct transmission or providing.

In this specification, the expression described by the singular can be interpreted as a singular or plurality, unless an explicit expression such as “one” or “single” is used.

Hereinafter, a preferable embodiment of the present disclosure will be described in detail with reference to the accompanying drawings. In the drawings, the same reference numeral is used for representing the same or similar components.

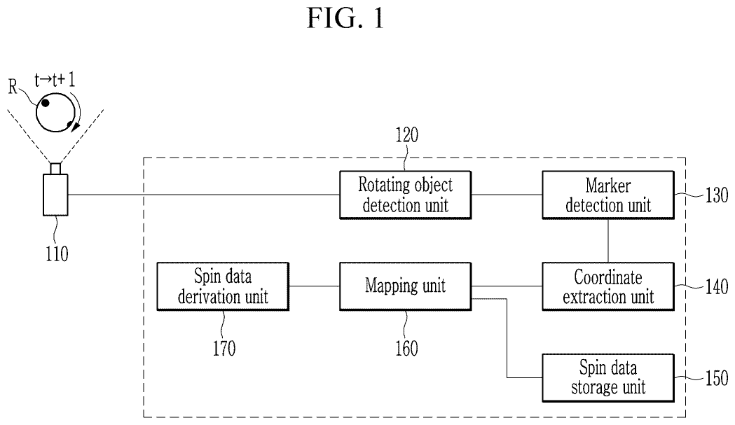

FIG. 1 is an explanatory diagram schematically illustrating a configuration of an apparatus for measuring spin data of a rotating object according to an exemplary embodiment of the present disclosure.

Referring to FIG. 1, the apparatus for measuring spin data of a rotating object according to the exemplary embodiment of the present disclosure includes a camera 110, a rotating object detection unit 120, a marker detection unit 130, a coordinate extraction unit 140, a spin data storage unit 150, a mapping unit 160, and a spin data derivation unit 170.

A plurality of markers may be provided on an external surface of a rotating object R applied to the apparatus for measuring spin data of a rotating object according to the exemplary embodiment of the present disclosure.

The apparatus for measuring spin data of a rotating object according to the exemplary embodiment of the present disclosure may obtain spin data (an angle, a spin rate, etc., of a rotation axis) of a rotating object R through only mapping location coordinates (pixel coordinates) of a marker formed on an external surface of the rotating object R obtained from a camera, and spin data stored in a spin data storage unit 150 constructed in advance.

The camera 110 may be preferably a high-speed camera having a photographing speed of 1000 frame per second (FPS) or more, and may be advantageous for calculating a more accurate rotation amount as the camera has a higher FPS.

The rotating object detection unit 120 detects an image of the rotating object R with respect to an image of N frames captured for a time t+1 at t by the camera 110. Specifically, the rotating object detection unit 120 extracts pixels of a foreground image by removing pixels of a background image from the image captured through the camera 110, and classifies the extracted pixels of the foreground image into interconnected clusters to extract a pixel cluster of the foreground image. Thereafter, a size or a shape of the extracted pixel cluster of the foreground image is obtained to extract a pixel cluster having a size or shape closet to a spherical object as an image of the rotating object.

The marker detection unit 130 selectively detects only an image of a marker in the rotating object image detected by the rotating object detection unit 120.

The coordinate extraction unit 140 extracts 2-dimensional location coordinates (hereinafter, also referred to as ‘pixel coordinates’) of the marker from the image of the marker detected by the marker detection unit 130.

The spin data storage unit 150 stores spin data of a rotating object derived by a 3D spin simulator (not illustrated). In this case, the spin data may be constructed for each type of rotating object, and the type of each rotating object may be distinguished according to the number of markers, or a shape of the marker. In FIG. 1, it is illustrated that the spin data storage unit 150 is positioned inside the apparatus for measuring spin data of the rotating object, but the present disclosure is not limited thereto, and the spin data storage unit 150 may also be configured to be installed in an external server of the apparatus for measuring spin data of the rotating object, and access the apparatus through a network.

Specifically, the 3D spin simulator performs a spin simulation of the rotating object based on a combination of a rotation axis and a rotation amount of a rotating object (e.g., a golf ball), and captures a marker image of the rotating object of on a camera top view provided in the simulation when performing the simulation according to each combination of the rotation axis/rotation amount to obtain entire marker 2D location (x, y) pixel information. In addition, a rotation axis angle α and a rotation amount angle θ of the rotating object, and an x coordinate and a y coordinate of the marker are used as a set (α, θ, x, and y) to construct rotating object spin data and store the constructed rotating object spin data in the spin data storage unit 150. In the exemplary embodiment of the present disclosure, a simulation engine provided by the Unity is used as the 3D spin simulator, but the present disclosure is not limited thereto, and various other simulation engines may be used.

The mapping unit 160 maps the spin data (α, θ, x, and y) of the rotating object stored in the spin data storage unit 150, and the location coordinates (pixel coordinates) of the rotating object marker extracted by the coordinate extraction unit 140, and derives a difference between an angle of a common rotation axis, and a rotation amount. That is, the mapping unit 160 maps a location coordinate list of the rotating object marker extracted in an image of the rotating object of n frames captured by the camera 110 for a time t+1 at t, and a spin data list of the rotating object stored in the spin data storage unit 150, and derives the difference between the angle of the common rotation axis, and the rotation amount.

The spin data derivation unit 170 derives a rotation axis and a spin rate (a back spin speed and a side spin speed) which are final spin data based on the difference between the angle and the rotation amount of the common rotation axis derived by the mapping unit 160.

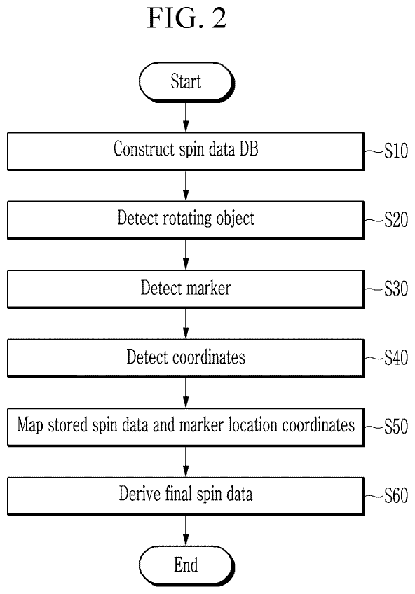

FIG. 2 is a flowchart for describing a method for measuring spin data of a rotating object according to an exemplary embodiment of the present disclosure.

Referring to FIG. 2, first, the spin data of the rotating object is derived by using the 3D spin simulator, and stored in the spin data storage unit 150 construct a spin data DB (S10)

In this case, the spin data may be constructed for each type of rotating object, and the type of each rotating object may be distinguished according to the number of markers, or a shape of the marker.

Thereafter, the rotating object detection unit 120 detects an image of the rotating object R for each frame with respect to an image of N frames captured by the camera 110 for the time t+1 at t (S20).

The marker detection unit 130 selectively detects only the image of the marker in the rotating object image for each frame detected by the rotating object detection unit 120 (S30).

The coordinate extraction unit 140 extracts coordinate values (location coordinate list) of the marker from the image of the marker for each frame detected by the marker detection unit 130 (S50).

The mapping unit 160 maps location coordinates (location coordinate list) of the rotating object marker extracted by the coordinate extraction unit 140, and the spin data of the rotating object stored in the spin data storage unit 150, and derives a difference between the common rotation axis and the rotation amount (S60).

The spin data derivation unit 170 derives an angle and a spin rate of the rotation axis which are final spin data based on the difference between the common rotation axis and the rotation amount derived by the mapping unit 160 (S70).

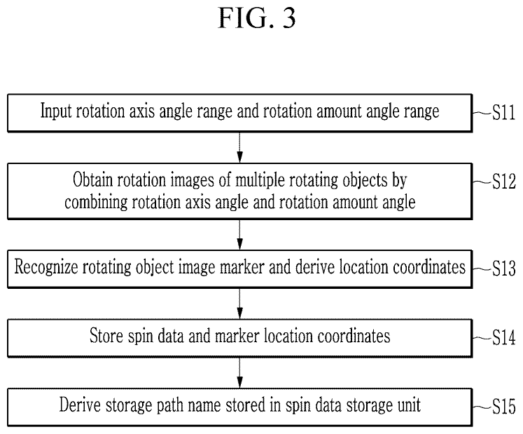

FIG. 3 is a flowchart more specifically describing step S10 in FIG. 2.

First, a range (αₘᵢₙ and αₘₐₓ) of a rotation axis angle α of the rotating object and a range (θₘᵢₙ and θₘₐₓ) of a rotation amount angle θ of the rotating object to be constructed as a database are input into the 3D spin simulator (S11).

Thereafter, the rotation axis angle α and the rotation amount angle θ are combined within a set range to obtain spin images of multiple rotating objects (S12). Specifically, the 3D spin simulator virtually rotates the rotating object based on multiple 3D spin data obtained by combining the rotation axis angle α and the rotation amount angle θ within the angle range (αₘᵢₙ and αₘₐₓ) of the rotation axis and the angle range (θₘᵢₙ and θₘₐₓ) of the rotation amount of the rotating object input in step S11, and then captures a top-view image of the rotating object by using an internal camera of the simulator function, and stores the captured top-view image

Then, the marker is recognized in the captured rotating object, and location coordinates (x, y) of the marker are derived on the image (S13).

Thereafter, the spin data (rotation axis angle and the rotation amount angle) of the rotating object, and the location of the marker are matched and stored (S14)

That is, data (α, θ, x, and y) in which the rotation axis angle α, the rotation amount angle θ, the location coordinates (x, y) of the marker corresponding to a rotation image of each rotating object are configured as a set is stored to construct a spin data database.

In addition, a storage path name DB_path stored in the spin data storage unit 150 is derived (S15). This is to access corresponding data through the storage path name when using the spin data storage unit 150 in the future.

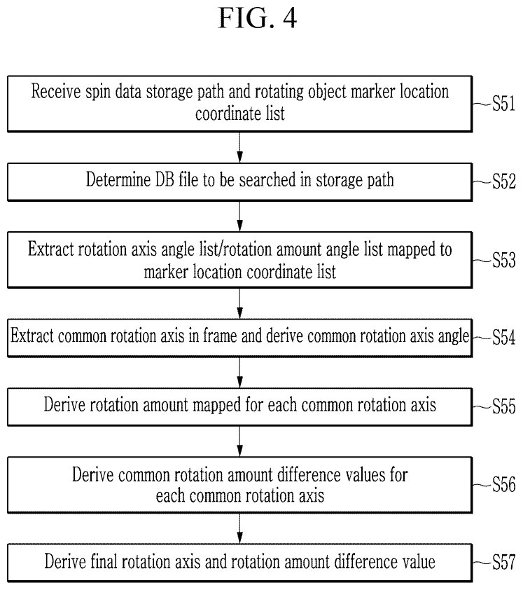

FIG. 4 is a flowchart more specifically describing step S50 in FIG. 2.

First, a storage path DB_path of spin data, and a location coordinate list frames_marker_pos_list of a rotating object marker extracted from a camera image are received (S51). Specifically, a location coordinate list of the marker detected by the marker detection unit 130, and a storage path of the spin data storage unit 150 storing the spin data are received. Besides, pattern information of the rotating object marker (the number of markers or array information), and limited ranges thres_spin data of the angle and the spin rate of the rotation axis of the rotating object may be received.

Then, a DB file (a spin data file) to be searched within the storage path of the spin data storage unit 150 is determined (S52).

Thereafter, based on the received location coordinate list of the marker, a rotation axis angle (α) list and a rotation amount angle (θ) list mapped to respective location coordinates of the rotating object marker are extracted from the DB file (spin data file) to be searched within the storage path (S53). In this case, when the spin data is constructed for each type of rotating object, a rotation axis angle (α) list and a rotation amount angle (θ) list mapped to respective location coordinates of the rotating object marker are extracted from the DB file corresponding to a corresponding rotating object type based on the pattern information of the rotating object marker received in step S51.

Thereafter, based on the rotation axis angle (α) list and the rotation amount angle (θ) list extracted in step S53, the common rotation axis in the frame is extracted and an angle α_{com} of the common rotation axis is derived (S54). In this case, the common rotation axis means a rotation axis common to multiple markers when there are a plurality of rotary axes corresponding to coordinates of one marker recognized by the camera.

Thereafter, a rotation amount angle mapped for each common rotation axis angle extracted in step S54 is derived (S55).

Then, a common rotation amount difference (rotation amount angle difference) value for each common rotation axis is derived (S56).

Thereafter, a difference value between an angle α_{fin} and a rotation amount of a final rotation axis is derived (S57). In this case, when there are multiple difference values between the angle and the rotation amount of the common rotation axis, if a maximum/minimum value difference deviates from limited ranges thres_spin_data of the rotation axis and the spin rate, multiple difference values may be listed except for a maximum/minimum value.

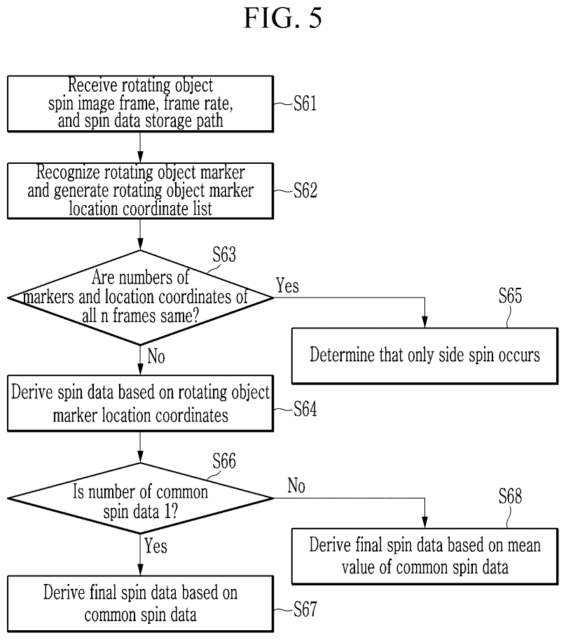

FIG. 5 is a flowchart more specifically describing step S60 in FIG. 2.

First, n frames continued in a rotating object spin image, a spin image frame rate, and a storage path DB_path of the spin data are received (S61). Besides, limited ranges thres_spin data of the rotation axis angle and the spin rate of the rotating object may be received.

Thereafter, only the image of the marker is recognized within the rotating object image, and location coordinates of the marker are extracted from the recognized image of the marker to generate a rotating object marker location coordinate list frames_marker_pos_list of n frames (S62).

Then, it is determined whether the numbers of markers and location coordinates of all n frames are the same (S63), and when the numbers of markers and location coordinates of all n frames are the same, it is determined that only side spin (that is, there is no back spin) occurs, and corresponding information is stored (S64).

According to a determination result in step S63, when the numbers of markers and location coordinates of all n frames are not the same, spin data is derived based on the rotating object marker location coordinates (S65). Specifically, spin data (rotation axis angle and rotation amount difference) mapped to rotating object marker location coordinate lists of n frames are derived by searching the spin data storage unit 150, and m common spin data common to the mapped spin data are derived

Thereafter, it is determined whether the number of m common spin data is 1 (S66), and when the number is 1, final spin data is derived based on one common spin data (S67). Specifically, the rotation axis angle of the rotating object is set to the final rotation axis angle α_{fin}, a spin rate spin rate_fin is obtained based on the rotation amount difference of the rotating axis and the frame rate, and then spin data including a final rotation axis, a final back spin rate, and a final side spin rate is derived based on the final rotation axis angle α_{fin} of the rotating object and the spin rate spin rate_fin of the rotating object.

In this case, the final back spin rate and the final side spin rate may be obtained by the following equation.

Final back spin rate=spin rate of rotating object*cos(α_{fin})

Final side spin rate=spin rate of rotating object*sin(α_{fin}) [Equation]

According to a determination result in step S66, when the number of common spin data is 2 or more, the final spin data is derived based on a mean value of the common spin data (S68). Specifically, a mean rotation axis angle αₘₑₐₙ of multiple common rotating object is set to the final rotation axis angle α_{fin}, the spin rate spin rate_fin is obtained based on a mean of the rotation amount difference of the rotation axis and the frame rate, and then the spin data including the final rotation axis, the final back spin rate, and the final side spin rate is derived based on the final rotation axis angle α_{fin} of the rotating object and the spin rate spin rate_fin of the rotating object.

As described above, according to exemplary embodiment of the present disclosure, spin data of a rotating object can be derived through only mapping pixel location coordinates of a rotating object marker, and spin data stored in a spin data storage unit constructed in advance, without conversion of actual space coordinates for the marker coordinates of the rotating object, so the spin data of the rotating object can be measured with a high speed and a small computation amount.

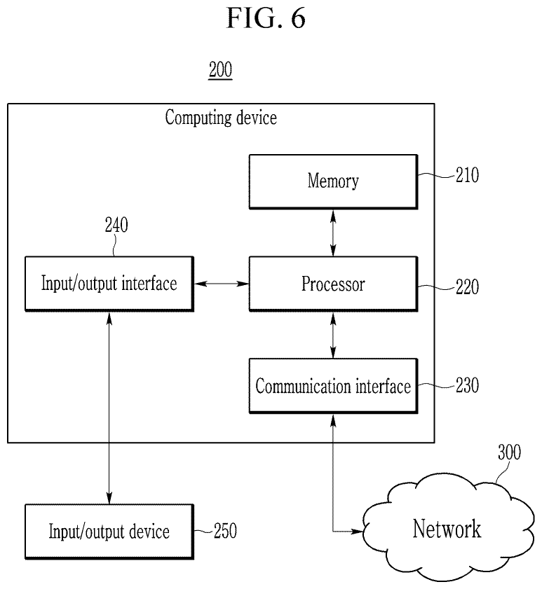

FIG. 6 is a diagram illustrating an example of a computing device according to an exemplary embodiment of the present disclosure. The spin data measurement apparatus of the rotating object described in FIG. 1 may be implemented by a computing device 200 illustrated in FIG. 6.

As illustrated in FIG. 6, the computing device 200 may include a memory 210, a processor 220, a communication interface 230, and an input/output interface 240. The memory 210 as a computer-readable recording medium may include permanent mass storage devices such as a random access memory (RAM), a read only memory (ROM), and a disk drive. Further, an operating system and at least one program code may be stored in the memory 210. The software components may be loaded to the memory 210 from a computer-readable recording medium separate from the memory 210. The separate computer-readable recording medium may include computer-readable recoding media such as a hard disk, a flash memory, an optical disk, an exterior hard disk, etc. Further, the software components may also be loaded to the memory 210 through the communication interface 230.

The processor 220 may be configured to process instructions of a computer program by performing basic arithmetic, logic, and input/output operations. The instructions may be provided to the processor 220 by the memory 210 or the communication interface 230.

The communication interface 230 may provide a function for the computing device 200 to mutually communicate with another device through the network 300.

The input/output interface 240 may be a means for interfacing with the input/output device 250. For example, the input device may include a device such as a microphone, a keyboard, or a mouse, and the output device may include a device such as a display or a speaker.

The exemplary embodiments described above may be implemented in a shape of a computer program which may be executed through various components on a computer, and such a computer program may be recorded in a computer-readable medium. In this case, examples of the media may include a hardware device particularly configured to store and execute program commands, magnetic media such as hard disks, floppy disks, and magnetic tape, optical recording media such as CD-ROM disks and DVD, magneto-optical media such as floptical disks, ROM, RAM, and flash memories.

If there is no description of the steps constituting the method according to the exemplary embodiments of the present disclosure, the steps may be performed in an appropriate order if there is no description of the order or contradictory. The present disclosure is not particularly limited according to the disclosed order of the above steps. The use of all examples or exemplary terms (e.g., etc.) in the present disclosure is to simply explain the present disclosure in detail, which is not limited to the scope of the present disclosure. In addition, it can be seen that by those skilled in the art, various modifications, combinations and changes within the claims and a scope equivalent thereto.

While the exemplary embodiments of the present disclosure have been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

110 Camera, 120 Rotating object detection unit, 30 Marker detection unit, 140 Coordinate extraction unit, 150 Spin data storage unit, 160 Mapping unit, 170 Spin data derivation unit, 200 Computing device, 210 Memory, 220 Processor, 230 Communication interface, 240 Input/output interface, 250 input/output device

What is claimed is:

1. An apparatus for measuring spin data of a rotating object, the apparatus comprising:
a rotating object detection unit detecting an image of a rotating object with respect to an image of n frames captured by a camera;
a coordinate extraction unit extracting location coordinates of a marker in the rotating object image detected by the rotating object detection unit;
a spin data storage unit in which spin data of the rotating object is stored in advance; and
a spin data derivation unit deriving final spin data based on the spin data of the rotating object stored in the spin data storage unit and the location coordinates of the marker extracted by the coordinate extraction unit.

2. The apparatus of claim 1, further comprising:
a mapping unit mapping the spin data of the rotating object stored in the spin data storage unit and the location coordinates of the marker extracted by the coordinate extraction unit, and deriving an angle of a common rotation axis and a difference of a rotation amount,
wherein the spin data derivation unit derives the final spin data including a rotation axis and a spin rate based on the angle of the common rotation axis and the difference of the rotation amount derived by the mapping unit.

3. The apparatus of claim 1, wherein:
the spin data of the rotating object stored in the spin data storage unit includes a rotation axis angle and a rotation amount angle of the rotating object, and location coordinates of a marker, and the spin data of the rotating object is derived by a 3D simulator.

4. The apparatus of claim 3, wherein:
the spin data of the rotating object is stored in the spin data storage unit for each type of rotating object distinguished according to the number of markers or a shape of the marker.

5. The apparatus of claim 2, wherein:
the mapping unit
extracts a rotation axis angle list and a rotation amount angle list mapped to each location coordinate of the rotating object marker from the spin data storage unit based on the location coordinate list of the marker extracted by the coordinate extraction unit, and
extracts the common rotation axis, and derives the angle of the common rotation axis based on the extracted rotation axis angle list and rotation amount angle lists.

6. A method for measuring spin data of a rotating object, the method comprising:
a first step of detecting an image of a rotating object with respect to an image of n frames captured by a camera;
a second step of extracting location coordinates of a marker within the detected rotating object image; and
a third step of deriving final spin data based on spin data of the rotating object stored in advance in a spin data storage unit and the extracted location coordinates of the marker.

7. The method of claim 6, comprising:
a fourth step of storing the spin data of the rotating object derived by using a 3D spin simulator in the spin data storage unit.

8. The method of claim 7, wherein:
the spin data of the rotating object is stored in the spin data storage unit for each type of rotating object distinguished according to the number of markers or a shape of the marker.

9. The method of claim 7, wherein:
the third step includes
mapping the spin data of the rotating object stored in the spin data storage unit and the extracted location coordinates of the marker, and deriving an angle of a common rotation axis and a difference of a rotation amount, and
deriving the final spin data including a rotation axis and a spin rate based on the derived angle of the common rotation axis and difference of the rotation amount.

10. The method of claim 7, wherein:
the fourth step includes
setting a range of a rotation axis angle of the rotating object and a range of a rotation amount angle of the rotating object to be constructed as a database,
combining the rotation axis angle and the rotation amount angle within the set ranges, and obtaining rotation images of multiple rotating objects,
recognizing a marker from the obtained rotation image of the rotating object, and deriving location coordinates of the marker on the image, and
mapping the spin data of the rotating object and a location of the marker, and storing the mapped spin data and location of marker in the spin data storage unit.

11. The method of claim 7, wherein:
the driving of the angle of the common rotation axis and the difference of the rotation amount includes
receiving a storage path in which the spin data is stored, and a list of the extracted location coordinates of the marker,
extracting a rotation axis angle list and a rotation amount angle list mapped to each location coordinate of the marker from the spin data storage unit based on the received location coordinate list of the marker and the storage path,
extracting the common rotation axis in the frame, and derives the angle of the common rotation axis based on the extracted rotation axis angle list and rotation amount angle lists, and
deriving a difference value between a rotation amount mapped for each extracted common rotation axis, and a common rotation amount.

12. The method of claim 7, wherein:
the deriving of the final spin data includes
generating rotating object marker location coordinate lists of n frames based on the extracted location coordinates of the marker,
extracting spin data mapped to the rotating object marker location coordinate lists of n frames from the spin data storage unit, and deriving common spin data common to the extracted spin data, and
deriving the final spin data based on the common spin data.

13. The method of claim 12, wherein:
when there are the plurality of common spin data, the final spin data is derived based on a mean value of the common spin data.

14. The method of claim 13, wherein:
the deriving of the final spin data based on the common spin data includes
setting a mean rotation axis angle of multiple common rotating objects to a final rotation axis angle, and deriving a spin rate of the rotating object based on a mean of a rotation amount difference of the rotation axis, and a frame rate, and
deriving the final spin data including a final rotation axis, a final back spin rate, and a final side spin rate based on the derived final rotation axis angle and the spin rate of the rotating object.

15. A computing device comprising:
at least one processor implemented to execute a computer-readable instruction,
wherein the at least one processor
detects an image of a rotating object with respect to an image of N frames captured by a camera,
extracts location coordinates of a marker within the detected rotating object image, and
derives final spin data based on spin data of the rotating object stored in advance in a spin data storage unit and the extracted location coordinates of the marker.
